(19) United States
(12) Patent Application Publication
(10) Pub. No.: US 2015/0169729 A1
(43) Pub. Date: Jun. 18, 2015

(54) DATA STORAGE DEVICE AND DATA STORING METHOD

(71) Applicants: FUJITSU LIMITED, Kawasaki-shi (JP); FUJITSU FSAS INC., Kawasaki-shi (JP)

(72) Inventors: Kenji KUMANO, Ichikawa (JP); NORIAKI AIHARA, Kawasaki (JP); ATSUSHI HAMADA, Kawasaki (JP)

(21) Appl. No.: 14/553,190

(22) Filed: Nov. 25, 2014

(30) Foreign Application Priority Data
Dec. 12, 2013 (JP) 2013-257451

(51) Int. Cl. G06F 17/30; G06F 21/62

(52) U.S. Cl. CPC G06F 17/30598; G06F 21/6245

(57) ABSTRACT

A receiving unit receives registration of data for a plurality of items. A storing unit classifies the data received by the receiving unit to corresponding items and stores them in respective storage destinations according to storage destination information indicating the storage destination of the data for each item.

### CROSS-REFERENCE TO RELATED APPLICATIONS

This application is based upon and claims the benefit of priority of the prior Japanese Patent Application No. 2013-257451, filed on Dec. 12, 2013, the entire contents of which are incorporated herein by reference.

### FIELD

The embodiments discussed herein are related to a data storage device, a data storing method, and a data storing program.

### BACKGROUND

Conventionally, various types of services are provided by knowledge workers who have various types of knowledge. For example, a certified nutritionist delivers a nutritional guidance service. The nutritional guidance is achieved, for example, in the following manner: a business enterprise commissions the nutritional guidance for its employees to a service provider, and a certified nutritionist who contracts with the service provider individually guides the employees. For example, the certified nutritionist requests the employees to report their own dietary habits and general life style through an individual interview or an e-mail. The certified nutritionist delivers a nutritional guidance based on their report. The certified nutritionist then reports the results of the individual guidance for the employees to the service provider. The service provider submits the report including all of the results of the employees that is the subject of the commission. This completes the commission of the nutritional guidance. The details of the guidance delivered by the certified nutritionist to the individual employees are organized as a result of the guidance. The service provider collects the pieces of data of the employees to deliver it to the business enterprise as the client. Conventional technologies are described in Japanese Laid-open Patent Publication No. 2009-175900, for example.

The data of results derived from the guidance actually delivered by the certified nutritionist is related to the job commissioned by the business enterprise through the service provider. After the contract of the commission is expired, the data of results derived from the guidance is entirely stored in the business enterprise that is the client of the commission, or the service provider that is the undertaker.

Recently, the development of data analysis technologies has found a certain value on the data of the guidance generated in the course of the tasks achieved by the certified nutritionist in addition to the data of results derived from the guidance delivered by the certified nutritionist. For example, if a certified nutritionist delivers a nutritional guidance to a plurality of persons, analysis is conducted on the data of the individual nutritional guidance in addition to the data of the results such as how many persons received the nutritional care. This leads to acquiring the results related to the quality of the job or the skills as a certified nutritionist in addition to the amount of the job achieved by the certified nutritionist.

The data of the guidance may, however, include the private information of the employees. The whole of the data is therefore not provided to the certified nutritionist. The data of the guidance may also include unnecessary details, leading to consume a large amount of resource such as a storage space and hinder the efficient use of the data.

The foregoing issues are not limited to the job related to certified nutritionists, but generally apply to knowledge workers such as a certified caregiver who delivers a nursing care service.

### SUMMARY

According to an aspect of an embodiment, a data storage device includes a receiving unit that receives registration of data for a plurality of items; and a storing unit that classifies the data received by the receiving unit for corresponding items and stores the data in respective storage destinations according to storage destination information indicating the storage destination of the data for each item.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram of the schematic configuration of a data storage device according to a first embodiment of the present invention;

FIG. 2 is a diagram illustrating an example of the functional configuration of the data storage device according to the first embodiment;

FIG. 3 is a diagram illustrating an example of the data organization of a knowledge worker table according to the first embodiment;

FIG. 4 is a diagram illustrating an example of the data organization of a qualification table according to the first embodiment;

FIG. 5 is a diagram illustrating an example of the data organization of a task record table according to the first embodiment;

FIG. 6 is a diagram illustrating an example of the data organization of a service unit table according to the first embodiment;

FIG. 7 is a diagram illustrating an example of the data organization of a service role table according to the first embodiment;

FIG. 8 is a diagram illustrating an example of the data organization of an assignment table according to the first embodiment;

FIG. 9 is a diagram illustrating an example of the data organization of a job source table according to the first embodiment;

FIG. 10 is a diagram illustrating an example of the data organization of a job table according to the first embodiment;

FIG. 11 is a schematic diagram illustrating an example flow of generating data to be stored according to the first embodiment;

FIG. 12 is a diagram illustrating an example of a nursing care plan input screen for inputting a plan of nursing care according to the first embodiment;

FIG. 13 is a diagram illustrating an example of a design template according to the first embodiment;

FIG. 14 is a diagram illustrating an example of a variable template according to the first embodiment;

FIG. 15 is a diagram illustrating an example of a data template according to the first embodiment;

FIG. 16 is a diagram illustrating an example of the data template according to the first embodiment;

FIG. 17 is a diagram illustrating an example of the job table that stores therein data according to the first embodiment;

FIG. 18 is a diagram illustrating an example of the task record table that stores therein data according to the first embodiment;

FIG. 19 is a diagram illustrating an example of a nursing care achievement input screen according to the first embodiment;

FIG. 20 is a diagram illustrating an example of the variable template according to the first embodiment;

FIG. 21 is a diagram illustrating an example of the job table that stores therein data according to the first embodiment;

FIG. 22 is a diagram illustrating an example of the task record table that stores therein data according to the first embodiment;

FIG. 23 is a flowchart illustrating an example process of storing data according to the first embodiment; and

FIG. 24 is a diagram illustrating a computer that executes a data storing program according to a second embodiment of the present invention.

### DESCRIPTION OF EMBODIMENTS

Preferred embodiments of the present invention will be explained with reference to accompanying drawings. The embodiments herein are not intended to limit the scope of the invention. The embodiments can be combined appropriately as long as the various types of processes performed in the embodiments are not contradictory to each other.

### [a] First Embodiment

### Configuration of Data Storage Device

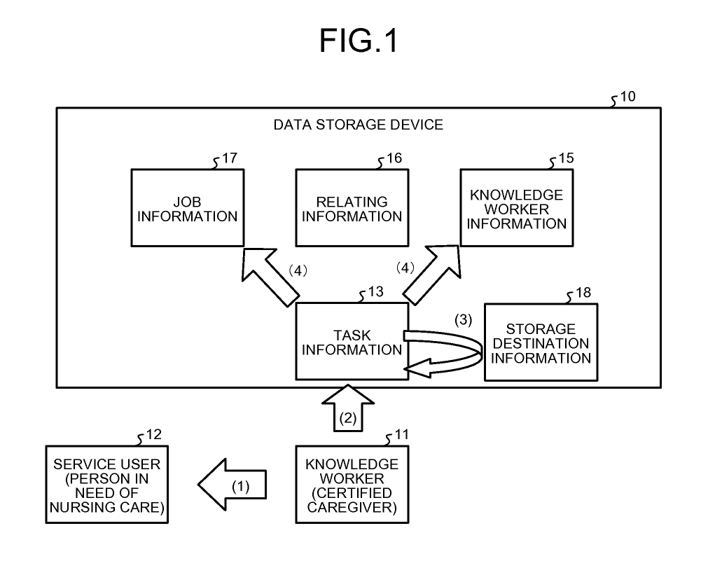

The following describes a data storage device 10 according to a first embodiment. FIG. 1 is a diagram of the schematic configuration of the data storage device. The data storage device 10 is a device in which a system operates. The system assigns a knowledge worker 11 a commissioned job and manages it. The knowledge worker 11 has certain knowledge and uses it to provide a service to a service user 12 (FIG. 1 (1)). In the present embodiment, a job refers to what the knowledge worker 11 performs. The knowledge worker 11 uses the knowledge to do the job. The job includes a target of a task and an effect. The equivalent results are always generated from the job by the knowledge workers each having a certain level of knowledge. The job is divided into units and has repeatability and reproducibility. The job is valuable and has repeatability.

In the present embodiment, a certified caregiver serving as the knowledge worker 11 provides a nursing care service to a person in need of nursing care as the service user 12. Nursing care services are achieved, for example, in the following manner: a nursing care for a person in need of nursing care is commissioned to a service provider, and the certified caregiver that contracts with the service provider individually visits the person in need of nursing care and delivers the nursing care service. The data storage device 10 receives registrations of various types of data relating to the commissioned job. For example, the data storage device 10 also receives a registration of information relating to the person in need of nursing care who requests the nursing care and a registration of information relating to details of the nursing care. The data storage device 10 receives registrations of various types of data relating to the nursing care from the certified caregiver. The certified caregiver uses a not-illustrated terminal device to register the various types of data relating to the nursing care in the data storage device 10 (FIG. 1 (2)). For example, the certified caregiver registers task information 13 relating to a task to be achieved in the data storage device 10. The task information 13 includes the private information of the person in need of nursing care such as the name of the person.

The data storage device 10 includes knowledge worker information 15, relating information 16, and job information 17 in which the data relating to the system is stored. The knowledge worker information 15 is data that contains various types of information relating to the knowledge worker 11. For example, the knowledge worker information 15 contains information relating to the name, the contact information, a possessed certification of the knowledge worker 11. The job information 17 is data that contains various types of information relating to the job. For example, the job information 17 contains information on the details of the commissioned nursing-care and information on the details of the provided nursing-care. The relating information 16 is data that contains information to relate the knowledge worker information 15 and the job information 17 to each other. For example, the relating information 16 contains information to relate the job contained in the job information 17 to the knowledge worker 11 contained in the knowledge worker information 15.

The knowledge worker information 15, the relating information 16, and the job information 17 are subject to access control according to their respective purposes of use. For example, the knowledge worker 11 has the authority to be able to access the knowledge worker information 15. That is, the knowledge worker information 15 is accessible by the knowledge worker 11. The client of the job has the authority to be able to access the job information 17. That is, the job information 17 is accessible by the client of the job and inaccessible by the knowledge worker 11. An administrator that manages the system has the authority to be able to access the relating information 16. That is, the relating information 16 is accessible by the administrator. If the job information 17 is subject to the access control as described above and the information of the task achieved by the knowledge worker 11 is stored in the job information 17, the knowledge worker 11 can hardly acquire the information of the task achieved by the knowledge worker 11 afterward as his/her own task achievement.

To resolve this, the data storage device 10 stores therein storage destination information 18 that indicates the storage destination of each item of the registered data. The data storage device 10 classifies the received data for the corresponding items and stores them in the respective storage destinations according to the storage destination information 18. For example, the data storage device 10 stores the information on the achieved task details in the job information 17 (FIGS. 1 (3) and (4)). The data storage device 10 also stores the information relating to the task excluding private information out of the task information 13 in the knowledge worker information 15 (FIGS. 1 (3) and (4)). This enables the data storage device 10 to separately store therein the data for a specified item out of the registered data. In this manner, the information relating to the task excluding the private information is separately stored in the knowledge worker information 15, thereby enabling the knowledge worker 11 to acquire the information of the task achieved by the knowledge worker 11 afterward as his/her own task achievement.

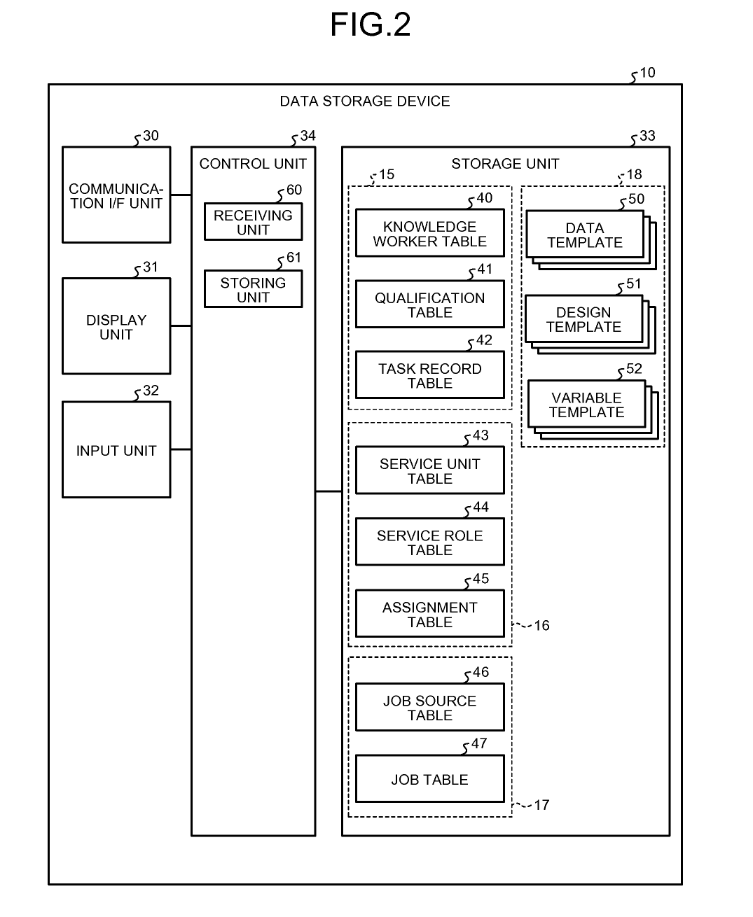

The data storage device 10 according to the first embodiment will now be described in greater details. FIG. 2 is a diagram illustrating an example of the functional configuration of the data storage device according to the first embodiment.

The data storage device 10 is, for example, a computer such as a personal computer and a server computer. The data storage device 10 may be implemented as one computer or a cloud including a plurality of computers. In the present embodiment, the data storage device 10 is implemented as one computer. As illustrated in FIG. 2, the data storage device 10 includes a communication interface (I/F) unit 30, a display unit 31, an input unit 32, a storage unit 33, and a control unit 34.

The communication I/F unit 30 is an interface for communicating with other devices. The communication I/F unit 30 exchanges various types of information with other devices through a not-illustrated network. For example, the communication I/F unit 30 transmits information on various types of screens to the terminal device carried by the knowledge worker 11. The communication I/F unit 30 also receives information on input results on various types of screens from the terminal device carried by the knowledge worker 11. Examples of an aspect of the communication I/F unit 30 include a network interface card such as a local area network (LAN) card.

The display unit 31 is a display device to display various types of information. Examples of the display unit 31 include a display device such as a liquid crystal display (LCD) and a cathode ray tube (CRT). The display unit 31 displays various types of information.

The input unit 32 serves as an input device used for inputting various types of information. Examples of the input unit 32 include an input device such as a mouse and a keyboard provided at the data storage device 10. The input unit 32 receives an operation input from a user and outputs the received operation information that represents the details of the operation input to the control unit 34.

The storage unit 33 is a storage device such as a hard disk, a solid state drive (SSD), and an optical disc drive. The storage unit 33 may be a rewritable semiconductor memory such as a random access memory (RAM), a flash memory, and a non-volatile static random access memory (NVSRAM).

The storage unit 33 stores therein the operating system (OS) and various types of computer programs executed by the control unit 34. The storage unit 33 also stores therein various types of the data used in a computer program executed by the control unit 34. For example, the storage unit 33 includes a knowledge worker table 40, a qualification table 41, a task record table 42, a service unit table 43, a service role table 44, and an assignment table 45. The storage unit 33 also includes a job source table 46, a job table 47, a data template 50, a design template 51, and a variable template 52.

The knowledge worker table 40, the qualification table 41, and the task record table 42 are examples of the knowledge worker information 15. The service unit table 43, the service role table 44, and the assignment table 45 are examples of the relating information 16. The job source table 46 and the job table 47 are examples of the job information 17. The data template 50, the design template 51, and the variable template 52 are examples of the storage destination information 18.

The knowledge worker table 40 is a table that stores therein the information relating to the knowledge worker 11. For example, the knowledge worker table 40 stores therein the name and the registration status of the knowledge worker 11.

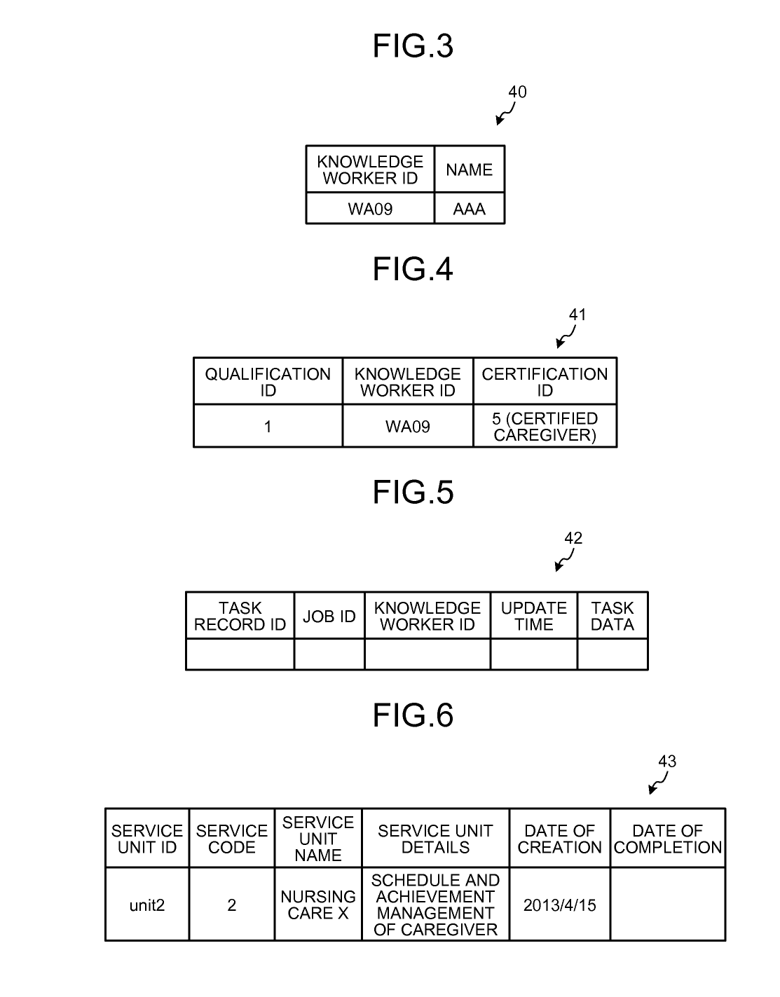

FIG. 3 is a diagram illustrating an example of the data organization of the knowledge worker table. As illustrated in FIG. 3, the knowledge worker table 40 includes the items “knowledge worker ID” and “name”. The knowledge worker identification (ID) item is a field that stores therein the identifying information to identify the knowledge worker 11. Each of the knowledge workers 11 is provided with the identifying information including numbers and letters to identify the knowledge worker 11 individually. The knowledge worker ID item stores therein the knowledge worker ID provided to the knowledge worker 11. The name item is a field that stores therein the name of the knowledge worker 11.

FIG. 3 illustrates that the knowledge worker 11 with the knowledge worker ID “WA09” has the name “AAA”.

Referring back to FIG. 2, the qualification table 41 is a table that stores therein the information relating to the certification held by the knowledge worker 11. For example, the qualification table 41 stores therein the information relating to the certification held by the knowledge worker 11.

FIG. 4 is a diagram illustrating an example of the data organization of the qualification table. As illustrated in FIG. 4, the qualification table 41 includes the items “qualification ID”, “knowledge worker ID”, and “certification ID”. The qualification ID item is a field that stores therein the identifying number of the certification held by the knowledge worker 11. The certification ID “5” indicates the certification of the certified caregiver. The knowledge worker ID item is a field that stores therein the identifying information to identify the knowledge worker 11. The certification ID item is a field that stores therein the identifying information to identify the certification.

In FIG. 4, the qualification ID “1” represents that the knowledge worker 11 with the knowledge worker ID “WA09” has the certification of the certified caregiver with the certification ID “5”.

Referring back to FIG. 2, the task record table 42 is a table that stores therein the task record of the tasks input by the knowledge worker 11. For example, the task record table 42 stores therein the information on the details relating to the nursing care input by the certified caregiver excluding private information.

FIG. 5 is a diagram illustrating an example of the data organization of the task record table. As illustrated in FIG. 5, the task record table 42 includes the items “task record ID”, “job ID”, “knowledge worker ID”, “update time”, and “task data”. The task record ID item is a field that stores therein the identifying information provided to the task record. Each of the task records has the identifying information provided to identify the task record individually. The task record ID item stores therein the identifying information provided to the task record. The job ID item is a field that stores therein the identifying information on the job to which the input task record attributes. Each of the jobs has the identifying information provided to identify the job. The job ID item stores therein the identifying information provided to the job. The knowledge worker ID item is a field that stores therein the identifying information to identify the knowledge worker 11. The update time item is a field that stores therein the date and time when the task record is registered. The task data item is a field that stores therein the data of the task record. The task data item stores therein the data of a plurality of items in the task record with tags.

Referring back to FIG. 2, the service unit table 43 is a table that stores therein the information for managing the provision source of the service. In the present embodiment, the service provider that provides the job including the nursing care is managed as a service unit. For example, the service unit table 43 stores therein the information on the service provider that provides the job including the nursing care.

FIG. 6 is a diagram illustrating an example of the data organization of the service unit table. As illustrated in FIG. 6, the service unit table 43 includes the items “service unit ID”, “service code”, “service unit name”, “service unit details”, “date of creation”, and “date of completion”. The service unit ID item is a field that stores therein the identifying information to identify the service unit. Each of the service units has the identifying information provided to identify the service unit individually. The service unit ID item stores therein the identifying information provided to the service unit. The service code item is a field that stores therein the code indicating the type of the service provided by the service unit. The service code “2” indicates that the type of the provided service is the nursing care. The service unit name item is a field that stores therein the name of the service unit. The service unit details item is a field that stores therein information relating to the task details provided by the service unit. The date of creation item is a field that stores therein the date of creation when the service unit is created. The date of completion item is a field that stores therein the date of completion when the service unit is completed.

FIG. 6 illustrates that the service unit with the service unit ID “unit 2” is related to the nursing care with the service code “2” and the service unit name is “nursing care X”. FIG. 6 also illustrates that the service unit with the service unit ID “unit 2” has the service unit details “schedule and achievement management of caregiver”. Because the date of creation item is “2013/4/15” and the date of completion item is blank, it is understood that the service unit is not completed and continuing.

Referring back to FIG. 2, the service role table 44 is a table that stores therein the user to be related to the service unit. In the present embodiment, the relation between the service unit and the user is managed as a service role. For example, the service role table 44 stores therein, for each of the service units, the manager that manages the job, the nursing-care helper who actually does the job, and the service user who is the subject of the task.

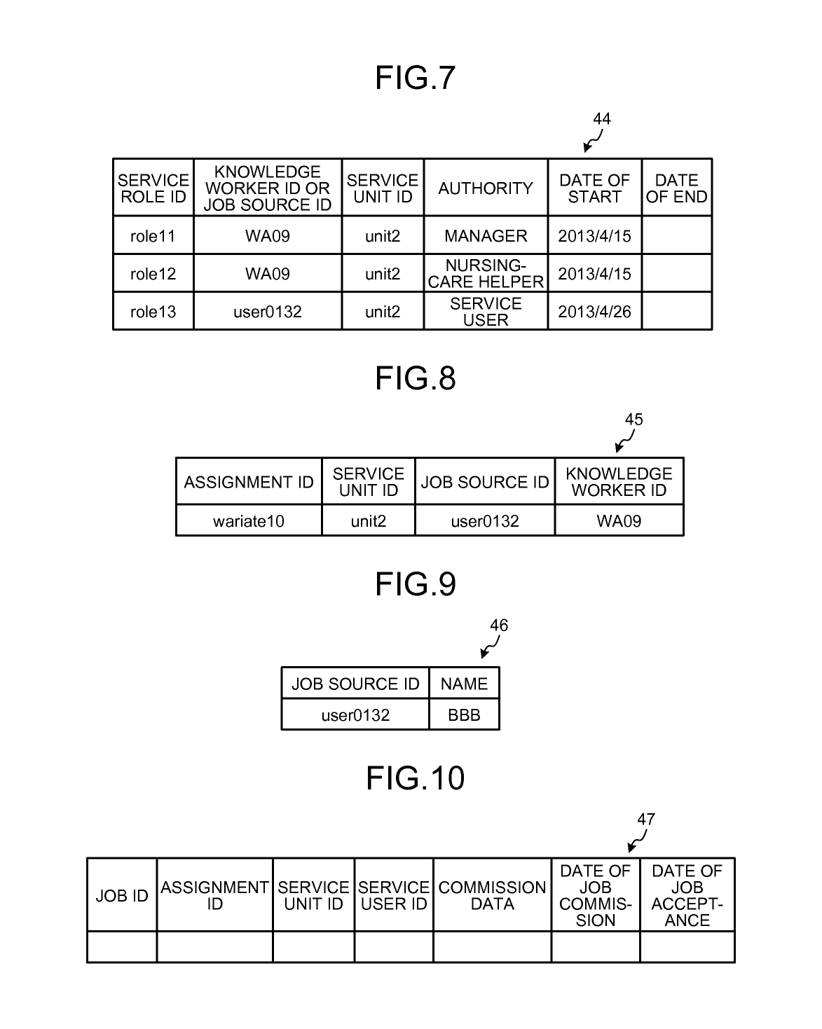

FIG. 7 is a diagram illustrating an example of the data organization of the service role table. As illustrated in FIG. 7, the service role table 44 includes the items “service role ID”, “knowledge worker ID or job source ID”, “service unit ID”, “authority”, “date of start”, and “date of end”. The service role ID item is a field that stores therein the identifying information to identify the service role. Each of the service roles has the identifying information provided to identify the service role individually. The service role ID item stores therein the identifying information provided to the service role. The knowledge worker ID or job source ID item is a field that stores therein the knowledge worker ID of the knowledge worker 11 or a later-described job source ID to be related to by the service role. The service unit ID item is a field that stores therein the service unit ID of the service unit to be related to by the service role. The authority item is a field that stores therein the authority provided to the related user of the system. The authority “manager” represents an authority as a manager who can assign the job. The authority “nursing-care helper” represents an authority as a nursing-care helper who actually does the job. The authority “service user” represents an authority as the service user 12 who uses the service. The user of the system who has the authority “manager” assigns the nursing-care helper a service user, thereby assigning the job. The date of start item is a field that stores therein the date of start on which the service role becomes valid. The date of end item is a field that stores therein the date of end on which the service role becomes invalid.

In FIG. 7, the service role ID “role 11” represents that the knowledge worker 11 with the knowledge worker ID “WA09” is related to the service unit with the service unit ID “unit 2”. The service role ID “role 11” also represents that the knowledge worker 11 with the knowledge worker ID “WA09” has the authority “manager”, the date of start is “2013/4/15”, and the date of end item is blank. This represents that the user of the system is valid. The service role ID “role 12” represents that the knowledge worker 11 with the knowledge worker ID “WA09” is related to the service unit with the service unit ID “unit 2”. The service role ID “role 12” also represents that the knowledge worker 11 with the knowledge worker ID “WA09” has the authority “nursing-care helper”, the date of start is “2013/4/15”, and the date of end item is blank. This represents that the user of the system is valid. That is, the knowledge worker 11 with the knowledge worker ID “WA09” has the authorities “manager” and “nursing-care helper”. The service role ID “role 13” represents that the job source with the job source ID “user0132” is related to the service unit with the service unit ID “unit 2”. The service role ID “role 13” also represents that the job source with the job source ID “user0132” has the authority “service user”, the date of start is “2013/4/26”, and the date of end item is blank. This represents that the user of the system is valid.

Referring back to FIG. 2, the assignment table 45 is a table that stores therein the assignment of the job. The assignment table 45 stores therein the service user 12 that is the job source, and the nursing-care helper who is in charge of the service user 12, for example, related to each other.

FIG. 8 is a diagram illustrating an example of the data organization of the assignment table. As illustrated in FIG. 8, the assignment table 45 includes the items “assignment ID”, “service unit ID”, “job source ID”, and “knowledge worker ID”. The assignment ID item is a field that stores therein the identifying information to identify the assignment. Each of the assignments has the identifying information provided to identify the assignment individually. The assignment ID item stores therein the identifying information provided to the assignment. The service unit ID item is a field that stores therein the service unit ID of the service unit to which the job is assigned. The job source ID item is a field that stores therein the identifying information of the service user 12 that is the job source. Each service user 12 that is the job source has the identifying information provided to identify the service user 12. The job source ID item stores therein the identifying information provided to the service user 12. The knowledge worker ID item is a field that stores therein the knowledge worker ID of the knowledge worker 11 who is in charge of the service user 12 having the job source ID.

In FIG. 8, the assignment ID “wariate10” represents that, in the service unit ID “unit 2”, the knowledge worker 11 with the knowledge worker ID “WA09” is assigned to the service user 12 with the job source ID “user0132”.

Referring back to FIG. 2, the job source table 46 is a table that stores therein information relating to the job source. In the present embodiment, the job source table 46 stores therein information on the service user 12 that is the job source.

FIG. 9 is a diagram illustrating an example of the data organization of the job source table. As illustrated in FIG. 9, the job source table 46 includes the items “job source ID” and “name”. The job source ID item is a field that stores therein the identifying information of the service user 12 that is the job source. The name item is a field that stores therein the name of the service user 12 who is the job source.

FIG. 9 illustrates that the job source ID “wariate10” has the name “BBB”.

Referring back to FIG. 2, the job table 47 is a table that stores therein the information relating to the job. For example, the job table 47 stores therein information relating to the task plan and the task achievement of the job.

FIG. 10 is a diagram illustrating an example of the data organization of the job table. As illustrated in FIG. 10, the job table 47 includes the items “job ID”, “assignment ID”, “service unit ID”, “service user ID”, “commission data”, “date of job commission”, and “date of job acceptance”. The job ID item is a field that stores therein the identifying information to identify the job. Each of the jobs has the identifying information provided to identify the job individually. The job ID item stores therein the identifying information provided to the job. The assignment ID item is a field that stores therein the assignment ID provided to the job. The service unit ID item is a field that stores therein the service unit ID of the service unit to which the job is assigned. The service user ID item is a field that stores therein the job source ID of the service user 12 who is the subject of the job. The commission data item is a field that stores therein the data related to the job details. The commission data item stores therein the data of a plurality of items in the task plan and the task achievement with tags. The date of job commission item is a field that stores therein the date of job commission on which the job is commissioned. The date of job acceptance item is a field that stores therein the date of end on which the tasks of the job end.

Referring back to FIG. 2, the data template 50, the design template 51, and the variable template 52 are information that indicate the storage destination of the data for each item. The data template 50, the design template 51, and the variable template 52 are provided more than one, respectively. In the present embodiment, the design template 51 and the variable template 52 are provided for each of the screens for registering data. The data template 50 is provided more than one corresponding to the tables serving as the storage destinations of the data. Each of the data templates 50 has the template number to identify the data template individually.

The control unit 34 is a device to control the data storage device 10. Examples of the control unit 34 include an electronic circuit such as a central processing unit (CPU) and a micro processing unit (MPU), or an integrated circuit such as an application specific integrated circuit (ASIC) and a field programmable gate array (FPGA).

The control unit 34 has an internal memory that stores therein a computer program in which various types of processes are specified, and control data. The control unit 34 executes various types of processes using the program and the control data. The various types of computer programs operate, whereby the control unit 34 functions as various types of processors. For example, the control unit 34 includes a receiving unit 60 and a storing unit 61.

The receiving unit 60 receives various types of data. For example, the receiving unit 60 receives registration of data for a plurality of items. For example, the receiving unit 60 transmits the information on a screen for registering data to the terminal device carried by the knowledge worker 11. This enables the terminal device to display thereon the screen for registering data. The receiving unit 60 then receives the registration of the data for the items from the screen.

The storing unit 61 stores therein various types of data. For example, the storing unit 61 stores the data received through the screen for registering data to the storage destinations by classifying the data for each item according to the data template 50, the design template 51, and the variable template 52. For example, the storing unit 61 identifies the table of the storage destination to which the data is stored based on the data template 50. The storing unit 61 stores the data for the item on the screen described in the design template 51, in the corresponding field in the identified table based on the variable template 52.

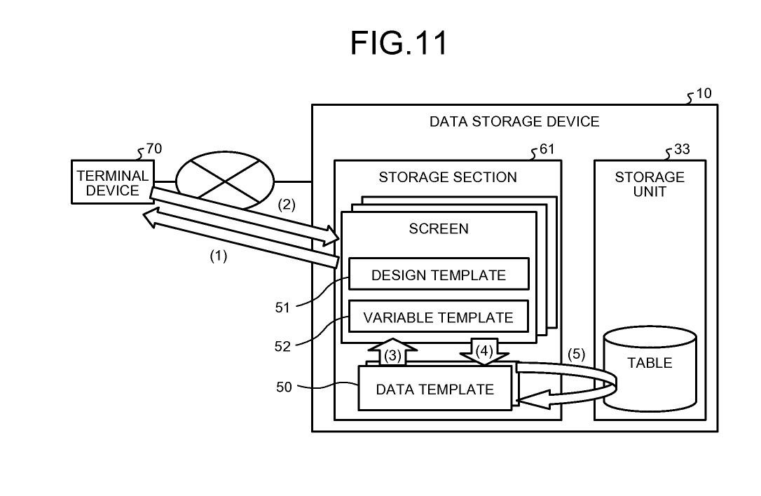

The following describes the flow of classifying the data for each item and storing the data to the storage destinations. FIG. 11 is a schematic diagram illustrating an example flow of generating data to be stored. If the knowledge worker 11 registers data, the knowledge worker 11 accesses the data storage device 10 through a terminal device 70. If the data storage device 10 is accessed, The storing unit 61 transmits the information on the screen for registering data to the terminal device 70, thereby displaying the screen for registering data on the terminal device 70 (FIG. 11 (1)).

The knowledge worker 11 registers the data on the screen for registering data displayed on the terminal device 70. The terminal device 70 transmits the data registered on the screen for registering data to the data storage device 10 (FIG. 11 (2)).

The design template 51 of the screen includes a template number for each screen used for updating the data.

The storing unit 61 identifies the data template 50 used for updating the data based on the template number included in the design template 51 corresponding to the screen (FIGS. 11 (3) and (4)). The storing unit 61 also identifies each item of the registered data based on the design template 51 corresponding to the screen for registering data. The storing unit 61 then identifies the items for which pieces of the data are stored together based on the variable template 52 corresponding to the screen for registering data. Subsequently, the storing unit 61 stores the pieces of the data registered on the screen for registering data in a data storage structure. After that, the storing unit 61 stores the data stored in the data storage structure in the corresponding field in the table using the data template 50 (FIG. 11 (5)).

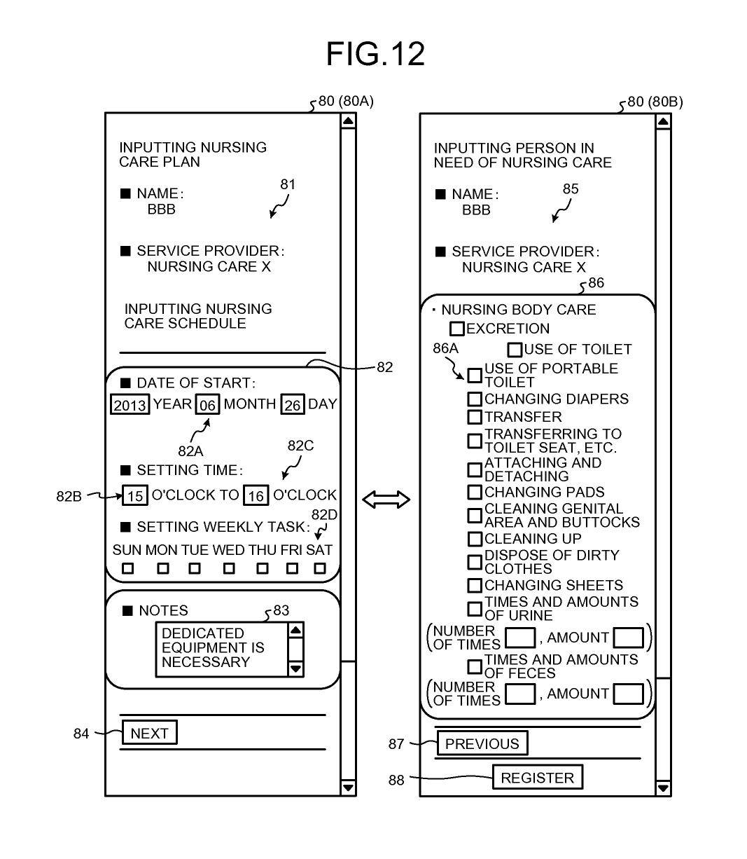

The following describes an example flow of classifying the data for each item and storing the data to the storage destinations. FIG. 12 is a diagram illustrating an example of a nursing care plan input screen for inputting a plan of nursing care. a nursing-care plan input screen 80 includes two screens: a nursing care plan input screen 80A and a nursing care plan input screen 80B.

The nursing care plan input screen 80A includes a field 81 that displays the name of the person in need of nursing care for whom a nursing care plan is input, and the name of the service unit that provides the nursing care service as a service provider name. The nursing care plan input screen 80A also includes a field 82 in which the nursing care plan is input. In the present embodiment, the field 82 includes a field 82A where the date of start is specified, a field 82B where the time of start is specified, a field 82C where the time of end is specified, and a field 82D where the day of the week is specified from Sunday to Saturday for the day to achieve the task. The nursing care plan input screen 80A also includes a field 83 where notes are input. The nursing care plan input screen 80A includes a Next button 84 to instruct the transition to the nursing care plan input screen 80B. If the Next button 84 is selected, the nursing care plan input screen 80A switches to the nursing care plan input screen 80B.

The nursing care plan input screen 80B includes a field 85 that displays the name of the person in need of nursing care for whom a nursing care plan is input, and the name of the service unit that provides the nursing care service as a service provider name. The nursing care plan input screen 80B also includes a field 86 where the details of the nursing care are input. In the present embodiment, the field 86 includes a field 86A where various types of items are specified on the nursing care for excretion as a nursing body care. The nursing care plan input screen 80B also has a Previous button 87 to instruct the transition to the nursing care plan input screen 80A. If the Previous button 87 is selected, the nursing care plan input screen 80B switches to the nursing care plan input screen 80A. The nursing care plan input screen 80B has a Register button 88. If the Register button 88 is selected, the items or details input on the nursing care plan input screen 80B are registered.

If the Register button 88 is selected on the nursing care plan input screen 80B, the terminal device 70 transmits the data registered on the nursing care plan input screen 80B to the data storage device 10.

The storing unit 61 identifies the data template 50 used for updating the data based on the template number included in the design template 51 corresponding to the screen.

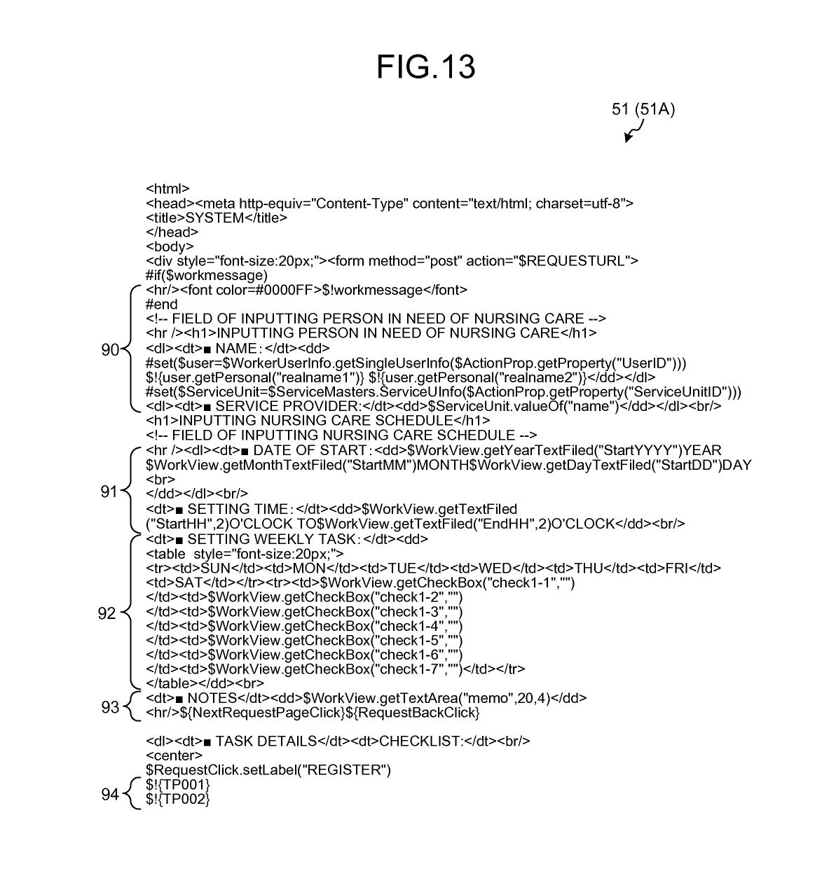

FIG. 13 is a diagram illustrating an example of the design template. FIG. 13 illustrates a design template 51A corresponding to the nursing care plan input screen 80A.

The design template 51A includes a field 90 where the codes are described for displaying the name of the person in need of nursing care for whom a nursing care plan is input, and the name of the service unit that provides the nursing care service as a service provider name. The design template 51A includes three fields: a field 91 where the codes are described for inputting the date of start, the time of start, and the time of end; a field 92 where the codes are described for specifying the day of the week from Sunday to Saturday; and a field 93 where the codes are described for inputting the notes. The design template 51A also includes a field 94 where the template numbers used for updating the data are described. In the present embodiment, the template numbers used for updating are set as fixed values “TP001” and “TP002” in the field 94. That is, “TP001” and “TP002” are equivalent to the template number.

The storing unit 61 identifies the items for which pieces of the data are stored together with reference to the variable template 52 corresponding to the screen. Subsequently, the storing unit 61 stores the pieces of the data registered on the screen for registering data in a data storage structure.

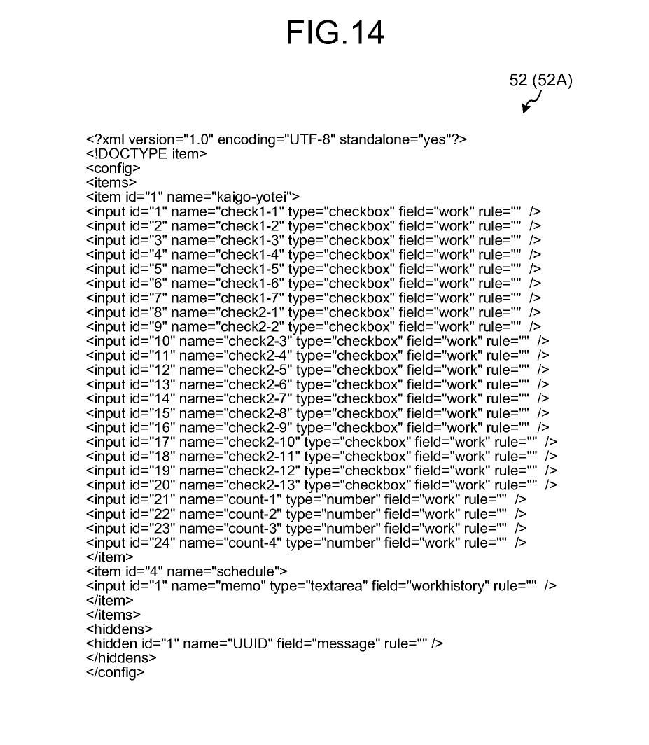

FIG. 14 is a diagram illustrating an example of a variable template. FIG. 14 illustrates a variable template 52A corresponding to the nursing care plan input screen 80.

In the variable template 52A, the items for which pieces of the data are stored together are defined for each table. In the present embodiment, the storage destination in which pieces of the data for the item described with “name=” are stored together is described with “field=”. For example, “field=“work” represents that the storage destination of the data is the job table 47. For another example, “field=“workhisroty”” represents that the storage destination of the data is the task record table 42. FIG. 14 illustrates that the storage destination of the data for the items from “name=“check1-1”” to “name=“count-4”” with the description of “field=“work”” is the job table 47. The items from “name=“check1-1”” to “name=“check1-7”” are the input items displayed in the field 82D on the nursing care plan input screen 80A. The items from “name=“check2-1”” to “name=“count-4”” are the input items displayed in the field 86A on the nursing care plan input screen 80B. FIG. 14 also illustrates that the storage destination of the data for the item “name=“memo”” with the description of “field=“workhisroty”” is the task record table 42.

The storing unit 61 identifies the data template 50 used for updating the data based on the template number included in the design template 51 corresponding to the screen. The storing unit 61 then stores the data stored in the data storage structure in the corresponding field in the table using the data template 50.

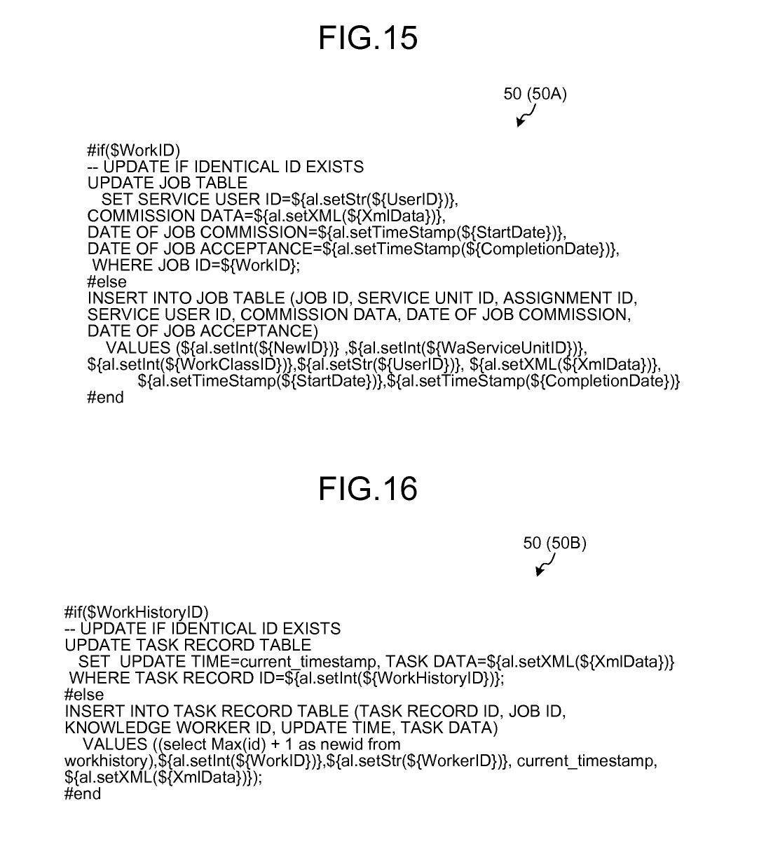

FIGS. 15 and 16 are diagrams illustrating examples of the data template. FIGS. 15 and 16 illustrate a data template 50A and a data template 50B that have the template numbers TP001 and TP002, respectively. In the data template 50A, the code to store the data in the job table 47 is described. In the data template 50B, the code to store the data in the task record table 42 is described.

In the data template 50A, the code is described using the structured query language (SQL). This code updates a record if the identical job ID is already registered in the job table 47, or adds a record if the job ID is not yet registered in the job table 47.

In the data template 50B, the code is described using the SQL. This code updates a record if the identical task record ID is already registered in the task record table 42, or adds a record if the task record ID is not yet registered in the task record table 42.

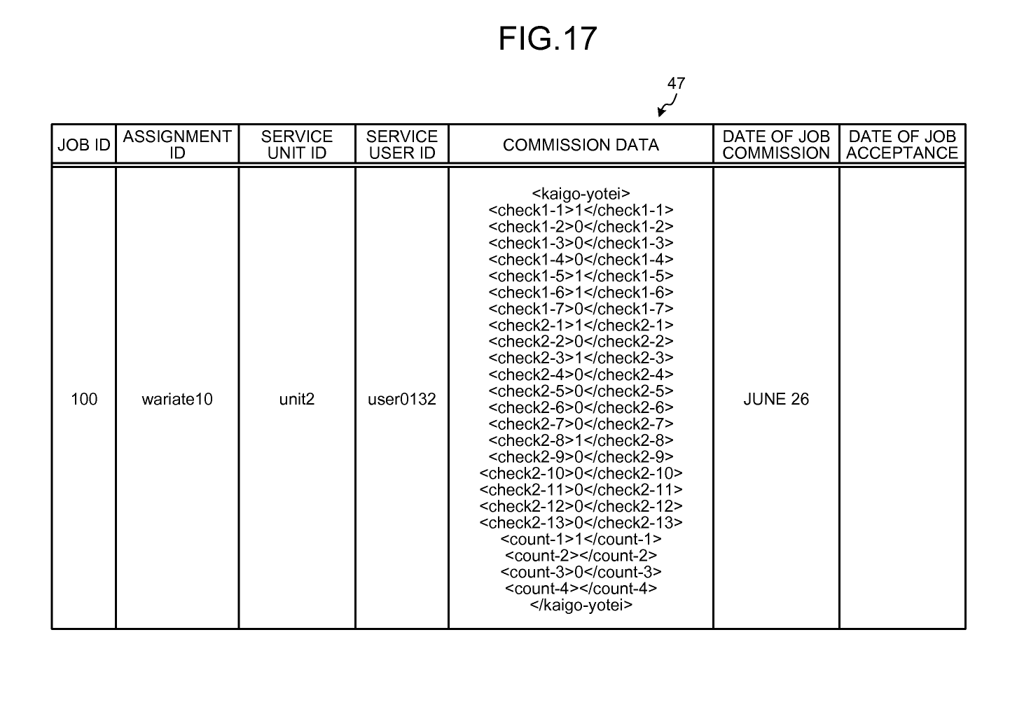

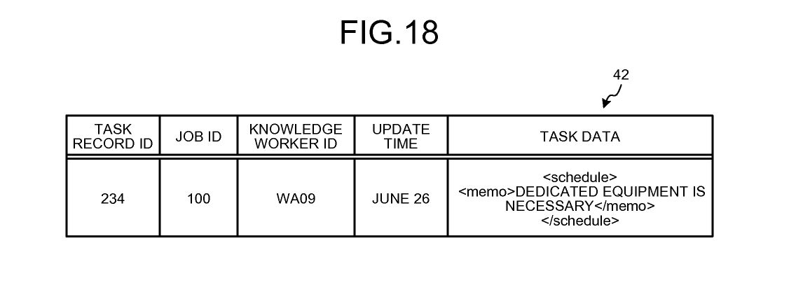

FIG. 17 is a diagram illustrating an example of the job table that stores therein data. FIG. 18 is a diagram illustrating an example of the task record table that stores therein data. FIGS. 17 and 18 illustrate example results of the registration on the nursing care plan input screen 80 illustrated in FIG. 12.

As illustrated in FIG. 17, the job table 47 stores therein the data for the items registered on the nursing care plan input screen 80. In particular, the commission data item stores therein the data of the input results for the input items displayed in the field 82D on the nursing care plan input screen 80A and the field 86A on the nursing care plan input screen 80B sequentially with being segmented with tags.

By contrast, as illustrated in FIG. 18, the task record table 42 stores therein the data for the items registered on the nursing care plan input screen 80. In particular, the task data item stores therein the data of the input results for the input item of notes in the field 83 on the nursing care plan input screen 80A with being segmented with tags.

Accordingly, the data storage device 10 according to the present embodiment can separately store the data for a specified item out of the registered data. In particular, the information relating to the task excluding private information is separately stored in the knowledge worker information 15, whereby the knowledge worker 11 can acquire the information of the task achieved by the knowledge worker 11 afterward as his/her own task achievement.

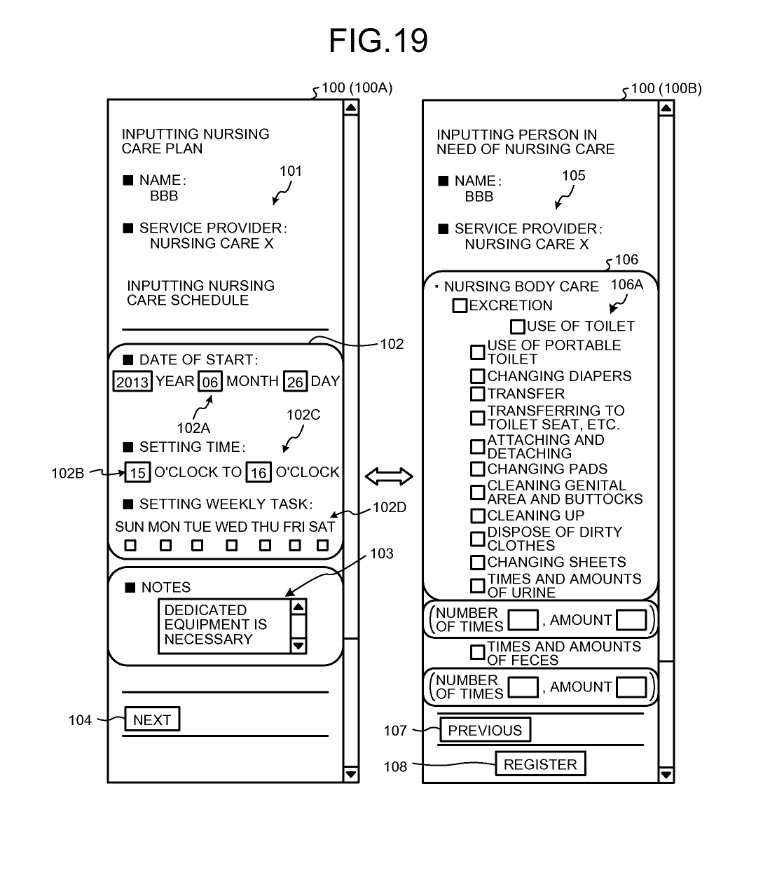

FIG. 19 is a diagram illustrating an example of a nursing care achievement input screen. a nursing care achievement input screen 100 has substantially the same screen organization as the nursing care plan input screen 80. That is, the nursing care achievement input screen 100 has two screens: a nursing care achievement input screen 100A and a nursing care achievement input screen 100B. On the nursing care achievement input screen 100, achievement of a nursing care is input using the plan data input on the nursing care plan input screen 80. For example, on the nursing care achievement input screen 100, the plan data is displayed that is retrieved from the job table 47 by using the service user ID and the date of start as conditions. FIG. 19 illustrates that the plan data registered on the nursing care plan input screen 80 illustrated in FIG. 12 is displayed on the nursing care achievement input screen 100.

The nursing care achievement input screen 100A includes a field 101 that displays the name of the person in need of nursing care for whom a nursing care plan is input, and the name of the service unit that provides the nursing care service as a service provider name. The nursing care achievement input screen 100A also includes a field 102 in which the schedule of the achieved nursing plan is input. In the present embodiment, the field 102 includes a field 102A where the date of start is specified, a field 102B where the time of start is specified, a field 102C where the time of end is specified, and a field 102D where the day of the week is specified from Sunday to Saturday for the day the task is achieved. The nursing care achievement input screen 100A also includes a field 103 where notes are input. The nursing care achievement input screen 100A includes a Next button 104 to instruct the transition to the nursing care achievement input screen 100B. If the Next button 104 is selected, the nursing care achievement input screen 100A switches to the nursing care achievement input screen 100B.

The nursing care achievement input screen 100B includes a field 105 that displays the name of the person in need of nursing care for whom a nursing care plan is input, and the name of the service unit that provides the nursing care service as a service provider name. The nursing care achievement input screen 100B also includes a field 106 where the details of the nursing care are input. In the present embodiment, the field 106 includes a field 106A where various types of items are specified on the nursing care for excretion as a nursing body care. The nursing care achievement input screen 100B also has a Previous button 107 to instruct the transition to the nursing care achievement input screen 100A. If the Previous button 107 is selected, the nursing care achievement input screen 100B switches to the nursing care achievement input screen 100A. The nursing care achievement input screen 100B has a Task complete button 108. If the Task complete button 108 is selected, the items or details input on the nursing care achievement input screen 100B are registered.

The design template 51 corresponding to the nursing care achievement input screen 100 is the same as the design template illustrated in FIG. 13 and description thereof is omitted here.

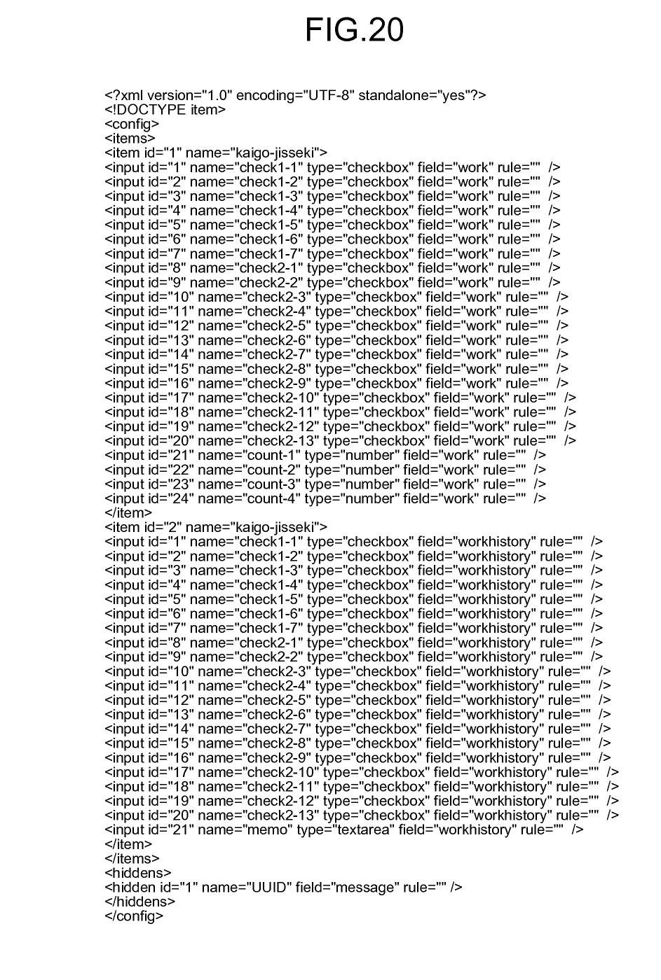

FIG. 20 is a diagram illustrating an example of the variable template. FIG. 20 illustrates a variable template 52B corresponding to the nursing care achievement input screen 100.

In the variable template 52B, the items for which pieces of the data are stored together are defined for each table. For example, “field=“work” represents that the storage destination of the data is the job table 47. For another example, “field=“workhisroty”” represents that the storage destination of the data is the task record table 42. FIG. 20 illustrates that the storage destination of the data for the items from “name=“check1-1”” to “name=“count-4”” with the description of “field=“work”” is the job table 47. The items from “name=“check1-1”” to “name=“check1-7”” are the input items displayed in the field 102D on the nursing care achievement input screen 100A. The items from “name=“check2-1”” to “name=“count-4”” are the input items displayed in the field 106A on the nursing care achievement input screen 100B. FIG. 20 also illustrates that the storage destination of the data for the items from name=“check1-1”” to “name=“count2-13”” and the item “name=“memo”” with the description of “field=“workhisroty”” is the task record table 42.

If the Task complete button 108 is selected on the nursing care achievement input screen 100B, the terminal device 70 transmits the data registered on the nursing care achievement input screen 100 to the data storage device 10.

The storing unit 61 identifies the data template 50 used for updating the data based on the template number included in the design template 51 corresponding to the nursing care achievement input screen 100. The storing unit 61 then identifies the items for which pieces of the data are stored together with reference to the variable template 52 illustrated in FIG. 20. Subsequently, the storing unit 61 stores the pieces of the data registered on the screen in a data storage structure. On this occasion, the storing unit 61 stores in the job table 47 only the data for the changed items registered on the nursing care achievement input screen 100.

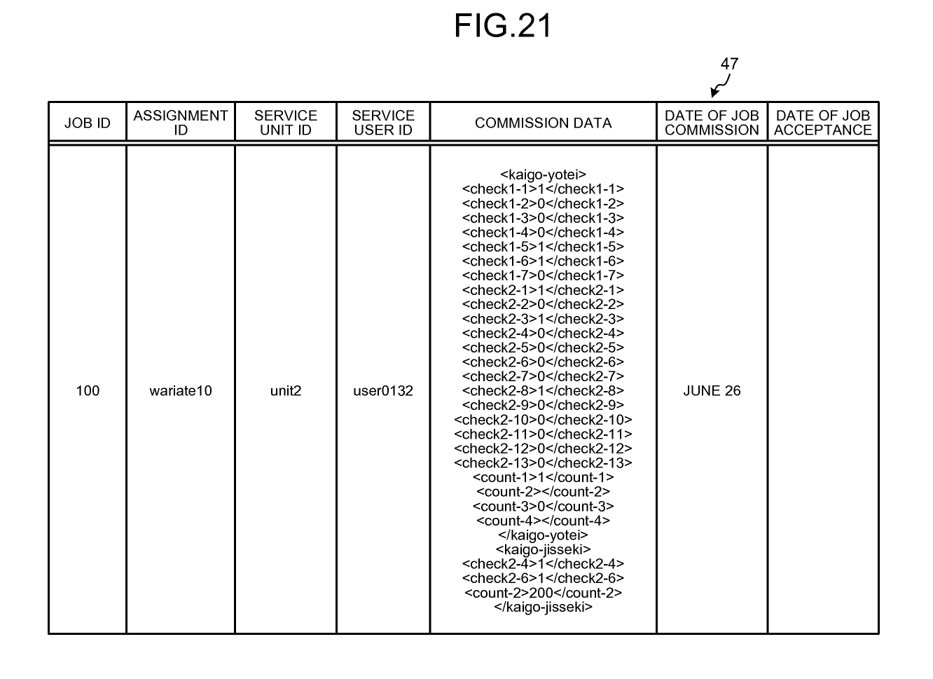

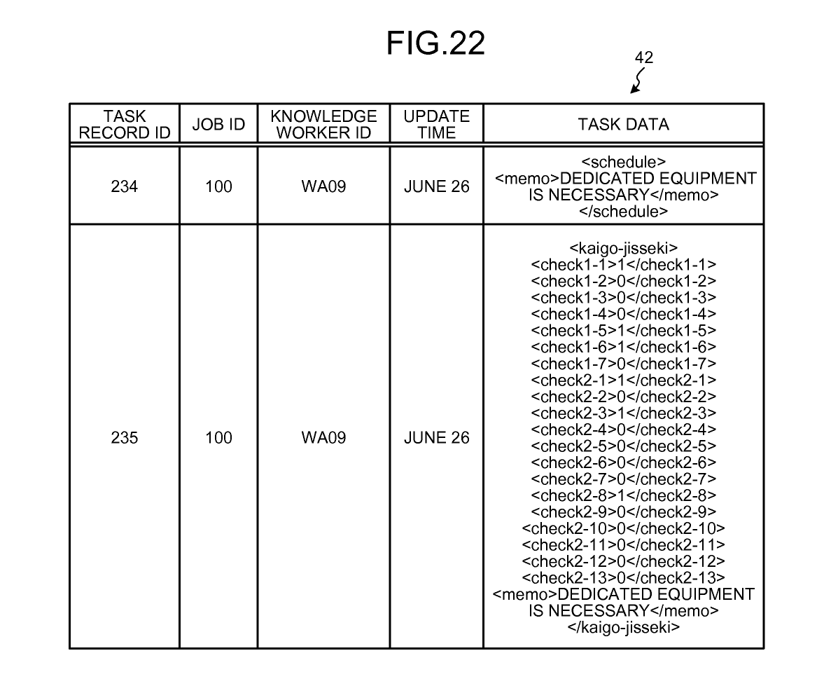

FIG. 21 is a diagram illustrating an example of the job table that stores therein data. FIG. 22 is a diagram illustrating an example of the task record table that stores therein data. FIGS. 21 and 22 illustrate example results of the registration on the nursing care achievement input screen 100 illustrated in FIG. 19.

As illustrated in FIG. 21, the job table 47 stores therein the data for the items registered on the nursing care achievement input screen 100. In particular, the commission data item additionally stores therein only the data for the changed items on the nursing care achievement input screen 100 with being segmented with tags.

As illustrated in FIG. 22, the task record table 42 stores therein the data for the items registered on the nursing care achievement input screen 100. The task record table 42 stores therein the registered data as a new record. In particular, the task data item stores therein the data of the input results related to a nursing body care out of the input items displayed in the field 102D on the nursing care achievement input screen 100A and the field 106A on the nursing care achievement input screen 100B sequentially with being segmented with tags.

In the present embodiment, the number of times of the nursing body care or the number of times and the amount of the excretion are defined as the private information of the person in need of nursing care. The task record table 42 therefore stores therein the achievement of the nursing care excluding the private information. That is, the task record table 42 stores therein only the data related to the tasks achieved separated from and excluding the private information. This enables the knowledge worker 11 to exhibit his/her experience and skills through the information stored in the task record table 42.

The data storage device 10 can separately store the data for a specified item out of the registered data. Excluding private information from the data to be stored ensures protection of private data and data storage of only specified items. This also enables the data storage device 10 to store therein the data of the type and the number of tasks achieved in addition to the number of persons received the nursing care.

Flow of Process

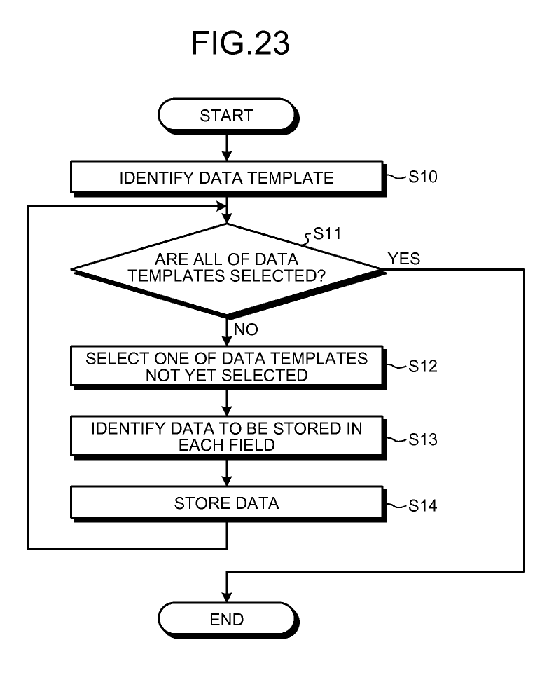

The following describes the flow of a process of storing data in the data storage device 10 according to the present embodiment. FIG. 23 is a flowchart illustrating an example process of storing data. This data storing process is executed when the registration of data is received from the screen for registering data.

As illustrated in FIG. 23, the storing unit 61 identifies the data template 50 used for updating the data based on the template number included in the design template 51 corresponding to the screen for registering data (S10). The storing unit 61 determines whether all of the identified data templates 50 are selected (S11). If the storing unit 61 determines that all of the identified data templates 50 are selected, (Yes at S11), the process ends.

By contrast, if the storing unit 61 determines that all of the identified data templates 50 are not selected, (No at S11), the storing unit 61 selects one of the data templates 50 not yet selected (S12). The storing unit 61 identifies the data to be stored based on the variable template 52 corresponding to the screen for registering data (S13). The storing unit 61 then stores the data in the corresponding field in the corresponding table using the data template 50 (S14) and the process proceeds to S11 described above.

### Advantageous Effects

The data storage device 10 according to the present embodiment receives registration of data for a plurality of items. The data storage device 10 then classifies the received data for the corresponding items and stores them in the respective storage destinations according to the storage destination information 18 indicating the storage destination of each item of the registered data. This enables the data storage device 10 to separately store therein the data for a specified item out of the registered data. Because the data storage device 10 classifies the registered data and stores them, if a storage destination of the data is subject to an access control, acquiring the data of a specified item stored in the storage destination under the access control is appropriately controlled. This ensures the security of the data.

The data storage device 10 according to the present embodiment may further include the job information 17 inaccessible by the knowledge worker 11, and the knowledge worker information 15 accessible by the knowledge worker 11. The storage destination information 18 defines the job information 17 as the storage destination of the data for the item including the private information of the service user. By contrast, the storage destination information 18 defines the knowledge worker information 15 as the storage destination of the data for the item related to the task achievement excluding the private information of the service user. The data storage device 10 therefore stores the data for the item including the private information out of the received data in the job information 17 and the data for the item related to the task achievement in the knowledge worker information 15. This enables the data storage device 10 to separately store the data related to the task achievement excluding the private information in the knowledge worker information 15.

The data storage device 10 according to the present embodiment displays the screen including a plurality of items related to the task details to receive registration of the data related to the task details by the knowledge worker 11. The storage destination information 18 includes the data template 50 indicating the table of the storage destination, the design template 51 indicating the items displayed on the screen, and the variable template 52 indicating the item on the screen that is stored in the corresponding field in the corresponding table. The data storage device 10 identifies the table of the storage destination to which the data is stored based on the data template 50. The data storage device 10 stores therein the data for the item on the screen described in the design template 51 in the corresponding field in the identified table based on the variable template 52. This enables the data storage device 10 to separately store therein the data for a specified item out of the data for the items displayed on the screen.

### [b] Second Embodiment

Although the embodiment relating to the disclosed apparatus has been described, the disclosed technique may be carried out in various modes different from the above-mentioned embodiment. Hereinafter, described are other embodiments encompassed by the invention.

In the above-described embodiment a certified caregiver serving as the knowledge worker 11 delivers a nursing care service to a person in need of nursing care who is the service user 12. This is provided merely for exemplary purpose and not limiting. For another example, a certified nutritionist serving as the knowledge worker 11 may deliver a nutritional guidance to employees in an organization who are the service users 12.

Furthermore, the components in the devices illustrated in the drawings are merely a depiction of concepts or functionality, and are not necessarily configured physically in the same manner as illustrated in the drawings. In other words, specific configurations in which the devices are divided or integrated are not limited to those illustrated in the drawings. More specifically, all or a part of the devices may be divided or integrated functionally or physically in any units depending on various loads or utilization. For example, the processors, that is, the receiving unit 60 and the storing unit 61 in the data storage device 10 may be integrated as appropriate. The process in each processor may be divided into processes in a plurality of processors as appropriate. All or a part of the processing functions executed in each of the processors may be implemented by a CPU and a computer program parsed and executed by the CPU, or implemented as hardware using wired logic.

Data Storing Program

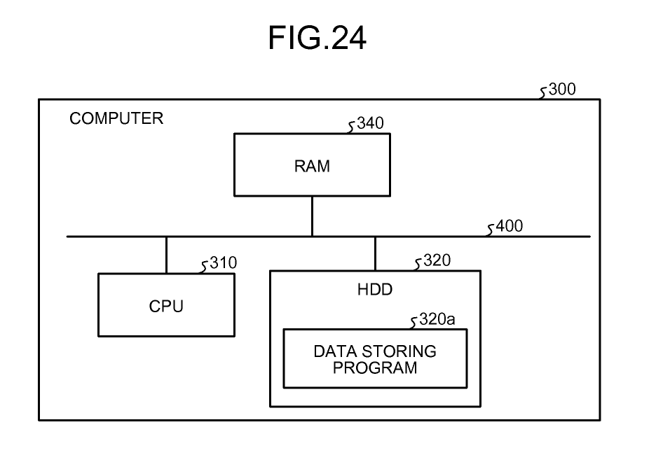

The various types of processes described in the embodiment can be performed by a computer system, such as a personal computer and a workstation, executing a computer program prepared in advance. The following describes an example of a computer system that executes a computer program having functions similar to those of the embodiment. FIG. 24 is a diagram illustrating a computer that executes a data storing program.

As illustrated in FIG. 24, a computer 300 includes a central processing unit (CPU) 310, a hard disk drive (HDD) 320, and a random access memory (RAM) 340. The components 300 to 340 are connected to one another via a bus 400.

The HDD 320 stores therein in advance a data storing program 320a that functions in the same manner as the receiving unit 60 and the storing unit 61 in the data storage device 10 described above. The data storing program 320a may be provided separately as appropriate.

The HDD 320 stores therein various types of information. For example, the HDD 320 stores therein the OS and various types of data used for storing data in a specified range.

The CPU 310 loads the data storing program 320a from the HDD 320 and executes the program, thereby performing the similar operations as those of the processors in the embodiment described above. That is, the data storing program 320a performs the similar operations as those of the receiving unit 60 and the storing unit 61.

The HDD 320 does not necessarily store therein in advance the data storing program 320a.

Each computer program may be stored in a “portable physical medium” inserted into the computer 300, such as a flexible disk (FD), a compact disc read only memory (CD-ROM), a digital versatile disc (DVD), a magneto-optical disc, and an integrated circuit (IC) card. The computer 300 may load each computer program from the portable physical medium to execute the computer program.

Furthermore, each computer program may be stored in another computer (or a server) coupled to the computer 300 via a public line, the Internet, a local area network (LAN), a wide area network (WAN), or the like. The computer 300 may load each computer program from these devices to execute the computer program.

According to an aspect of the present invention, data for a specified item out of the registered data can be separately stored.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A data storage device comprising:
a processor; and
a memory, wherein the processor executes a process comprising:
receiving registration of data for a plurality of items; and
classifying the received data for corresponding items and storing the data in respective storage destinations according to storage destination information indicating the storage destination of the data for each item.

2. The data storage device according to claim 1, wherein
the storage destination information defines a first storage unit that is inaccessible by a knowledge worker who has certain knowledge and achieves a task for a service user as the storage destination of the data for the item including private information of the service user, and defines a second storage unit that is accessible by the knowledge worker as the storage destination of the data for the item related to task achievement excluding the private information of the service user; and
the storing stores the data for the item including the private information out of the data received by the receiving unit in the first storage unit and stores the data for the item related to the task achievement in the second storage unit.

3. The data storage device according to claim 1, the process further comprising:
displaying a screen including a plurality of items related to task details to receive registration of data related to the task details by the knowledge worker and wherein; and
the storage destination information comprises a data template indicating a table of the storage destination, a design template indicating the data for the items displayed on the screen, and a variable template indicating the data for the item on the screen that is stored in a corresponding field in a corresponding table;
wherein the storing identifies a table of a storage destination to which data is stored based on the data template and stores the data for the item on the screen described in the design template in the corresponding field in the identified table based on the variable template.

4. A data storing method causing a computer to execute a process comprising:
receiving registration of data for a plurality of items; and
classifying the received data for corresponding items and storing the data in respective storage destinations according to storage destination information indicating the storage destination of the data for each item.

5. A computer-readable recording medium having stored therein a program for causing a computer to execute a process, the process comprising:
receiving registration of data for a plurality of items; and
classifying the received data for corresponding items and storing the data in respective storage destinations according to storage destination information indicating the storage destination of the data for each item.
